(19) United States
(12) Patent Application Publication
(10) Pub. No.: US 2019/0007931 A1
(43) Pub. Date: Jan. 3, 2019

(54) RADIO BASE STATION, USER TERMINAL AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 15/752,365

(22) PCT Filed: Aug. 9, 2016
(86) PCT No.: PCT/JP2016/073472

§ 371 Date: Feb. 13, 2018

(30) Foreign Application Priority Data
Aug. 14, 2015 (JP) 2015-160199
Sep. 24, 2015 (JP) 2015-187223

(51) Int. Cl. H04W 72/04; H04L 5/00; H04W 48/08

(52) U.S. Cl. CPC H04W 72/04; H04W 48/08; H04L 5/0048

(57) ABSTRACT

The present invention is designed to carry out communication adequately in cells (for example, unlicensed bands) where listening is executed prior to transmission. The present invention provides a transmission section that transmits a discovery measurement signal including first reference signals for channel state measurement, based on the result of listening, and a control section that controls resource allocation of the discovery measurement signal, and the control section assigns the first reference signals to be extended greater in a direction of time than existing second reference signals for channel state measurement.

### TECHNICAL FIELD

The present invention relates to a radio base station, a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, the specifications of LTE-advanced (Rel. 10 to 12) have been drafted for the purpose of achieving further broadbandization and higher speeds beyond LTE, and, in addition, for example, a successor system of LTE—referred to as “5G” (5th generation mobile communication system)—is under study.

The specifications of Rel. 8 to 12 LTE have been drafted assuming exclusive operations in frequency bands that are licensed to operators—that is, licensed bands. As licensed bands, for example, 800 MHz, 2 GHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone in unlicensed bands may become the subject of study under LAA.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”

Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

Now, a study is in progress to transmit, in unlicensed band cells, signals for use by UEs for RRM (Radio Resource Management) measurements and so on (referred to as, for example, the “discovery signal” (DS).

However, when an existing DS is used in a carrier that executes LBT like an unlicensed band, given that the DS includes symbols in which no signal is placed, there is a possibility that another system (for example, Wi-Fi) might succeed in LBT during the period the DS is transmitted. In this case, this system starts transmitting signals, and these signals will contend with the DS. It then becomes difficult to conduct cell search and/or RRM measurements in LAA accurately (with high reliability), and communication cannot be carried out adequately.

The present invention has been made in view of the above, and it is therefore an object of the present invention to provide a user terminal, a radio base station and a radio communication method whereby adequate communication can be carried out in in cells (for example, unlicensed bands) where listening is executed prior to transmission.

### Solution to Problem

According to one aspect of the present invention, a radio base station has a transmission section that transmits a discovery measurement signal including first reference signals for channel state measurement, based on the result of listening, and a control section that controls resource allocation of the discovery measurement signal, and, in this radio base station, the control section assigns the first reference signals to be expanded greater in a direction of time than existing second reference signals for channel state measurement.

### Advantageous Effects of Invention

According to the present invention, communication can be carried out adequately in cells (for example, unlicensed bands) where listening is executed prior to transmission.

### BRIEF DESCRIPTION OF DRAWINGS

FIG. 1 is a diagram to show an example of a radio resource configuration of an existing DRS;

FIG. 2A and FIG. 2B are diagrams to show examples of DRS radio resource configurations in which signals are mapped to be continuous in time;

FIG. 3A and FIG. 3B are diagrams to show examples of enhanced CSI-RS mapping methods, according to the present embodiment;

FIG. 4 is a diagram to show another example of an enhanced CSI-RS mapping method according to the present embodiment;

FIG. 5A and FIG. 5B are diagrams to show other examples of enhanced CSI-RS mapping methods according to the present embodiment;

FIG. 6A and FIG. 6B are diagrams to show other examples of enhanced CSI-RS mapping methods according to the present embodiment;

FIG. 7 is a diagram to show another example of an enhanced CSI-RS mapping method according to the present embodiment;

FIG. 8 is a diagram to explain the receiving operation by a user terminal for enhanced CSI-RSs according to the present embodiment and existing CSI-RSs;

FIG. 9 is a schematic diagram to show an example of a radio communication system according to the present embodiment;

FIG. 10 is a diagram to explain an overall structure of a radio base station according to the present embodiment;

FIG. 11 is a diagram to explain a functional structure of a radio base station according to the present embodiment;

FIG. 12 is a diagram to explain an overall structure of a user terminal according to the present embodiment;

FIG. 13 is a diagram to explain a functional structure of a user terminal according to the present embodiment.

FIG. 14 is a diagram to show an example case where a DRS and DL data are multiplexed in DMTC;

FIG. 15A and FIG. 15B are diagrams to show examples of CSI-RS configurations in DRSs when multiplexed with DL data, according to the present embodiment; and

FIG. 16A and FIG. 16B are diagrams to show examples of the method of mapping DRSs and broadcast information, according to the present embodiment.

### DESCRIPTION OF EMBODIMENTS

In systems (for example, LAA systems) that run LTE/LTE-A in unlicensed bands, interference control functionality is likely to be necessary in order to allow co-presence with other operators' LTE, Wi-Fi, or other different systems. Note that, systems that run LTE/LTE-A in unlicensed bands may be collectively referred to as “LAA,” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another UE) that is communicating in this unlicensed band carrier, the transmission point is disallowed to make transmission in this carrier.

So, the transmission point executes listening (LBT) at a timing that is a predetermined period ahead of a transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, UEs, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Also, this “listening” performed by radio base stations and/or user terminals may be referred to as “LBT,” “CCA,” “carrier sensing” and so on.

If it is confirmed that no other devices are communicating, the transmission point carries out transmission using this carrier. If the received power measured during LBT (the received signal power during the LBT period) is equal to or lower than a predetermined threshold, the transmission point judges that the channel is in the idle state (LBT_{idle}), and carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a predetermined threshold, the transmission point judges that the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame cycle, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “LBT time,” “carrier sensing period,” etc.) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

As described above, by introducing interference control for use within the same frequency that is based on LBT mechanisms to transmission points in LAA systems, it is possible to prevent interference between LAA and Wi-Fi, interference between LAA systems and so on. Furthermore, even when transmission points are controlled independently per operator that runs an LAA system, it is possible to reduce interference without learning the details of each operator's control, by means of LBT.

Now, in LAA systems, to configure and/or reconfigure unlicensed band SCells (Secondary Cells) in UEs, a UE has to detect SCells that are present in the surroundings by means of RRM (Radio Resource Management) measurements, measure their received quality, and then send a report to the network. The signal to allow RRM measurements in LAA is under study based on the discovery reference signal (DRS) that is stipulated in Rel. 12.

Note that the signal for RRM measurements in LAA may be referred to as the “discovery measurement signal,” the “discovery reference signal” (DRS), the “discovery signal” (DS), the “LAA DRS,” the “LAA DS” and so on. Also, an unlicensed band SCell may be referred to as, for example, an LAA SCell.

Similar to the Rel. 12 DRS, the LAA DRS may be constituted by a combination of synchronization signals (PSS (Primary Synchronization Signal)/SSS (Secondary Synchronization Signal)) and a CRS (Cell-specific Reference Signal) of existing systems (for example, LTE Rel. 10 to 12), a combination of synchronization signals (PSS/SSS), a CRS and a CSI-RS (Channel State Information Reference Signal) of existing systems, and so on.

Also, the network (for example, eNBs) can configure the DMTC

(Discovery Measurement Timing Configuration) of the LAA DRS in UEs per frequency. The DMTC contains information about the transmission cycle of the DRS (which may be also referred to as “DMTC periodicity” and so on), the offset of DRS measurement timings, and so on.

The DRS is transmitted per DMTC periodicity, in the DMTC duration. Here, according to Rel. 12, the DMTC duration is fixed to 6 ms. Also, the length of the DS (which may be also referred to as the “DRS occasion,” the DS occasion,” the “DRS burst,” the “DS burst” and so on) that is transmitted in the DMTC duration is between 1 ms and 5 ms. In LAA, too, the same configurations may be used, which is under study. For example, taking the time of LBT into account, the DRS occasion in the LAA DS may be made one subframe or shorter, or may be made one subframe or longer.

A UE learns the timings and the cycle of LAA DS measurement periods based on the DMTC reported from the network, and executes LAA DS measurements. Furthermore, a study is in progress to carry out CSI measurements by using the DRS, in addition to RRM measurements. CSI measurements can be performed by using, for example, the CRS, the CSI-RS and so on, included in the DRS.

A UE assumes that an existing DRS (Rel. 12 DRS) always includes a PSS, an SSS and a CRS port 0, and that a CSI-RS port 15 is included when configured by higher layer signaling.

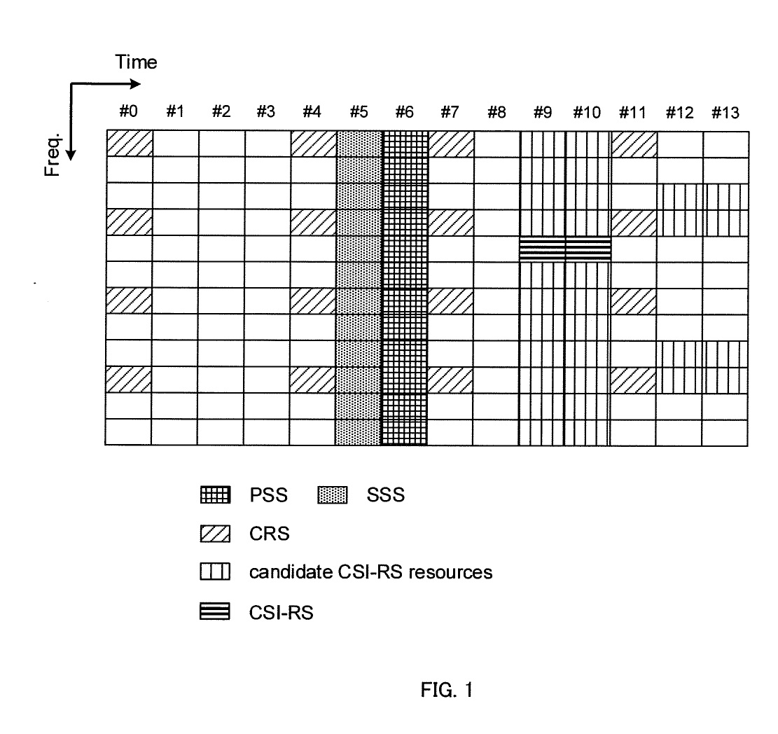

FIG. 1 is a diagram to show an example of a radio resource configuration of an existing DRS. As shown in FIG. 1A, in an existing DRS, CRSs (port 0) are mapped to symbols #0, #4, #7 and #11. Also, a PSS and an SSS are mapped to symbols #6 and #5. Furthermore, a CSI-RS is mapped, inside candidate CSI-RS resources. In the existing DRS, symbols #9 and #10 or symbols #12 and #13 can be used as candidate CSI-RS resources. Candidate CSI-RS resources may be referred to as candidate CSI-RS symbols.

When an existing DRS is used in a carrier that executes LBT like an unlicensed band, given that the DRS includes symbols that do not include signals (for example, symbols #1 to #3 and #8 in FIG. 1), there is a possibility that another system (for example, Wi-Fi) might succeed in LBT during the period the DRS is transmitted. In this case, this system starts transmitting signals, and these signals will contend with the DRS. Consequently, it becomes difficult to conduct cell search and/or RRM measurements in LAA accurately (with high reliability), and communication cannot be carried out adequately.

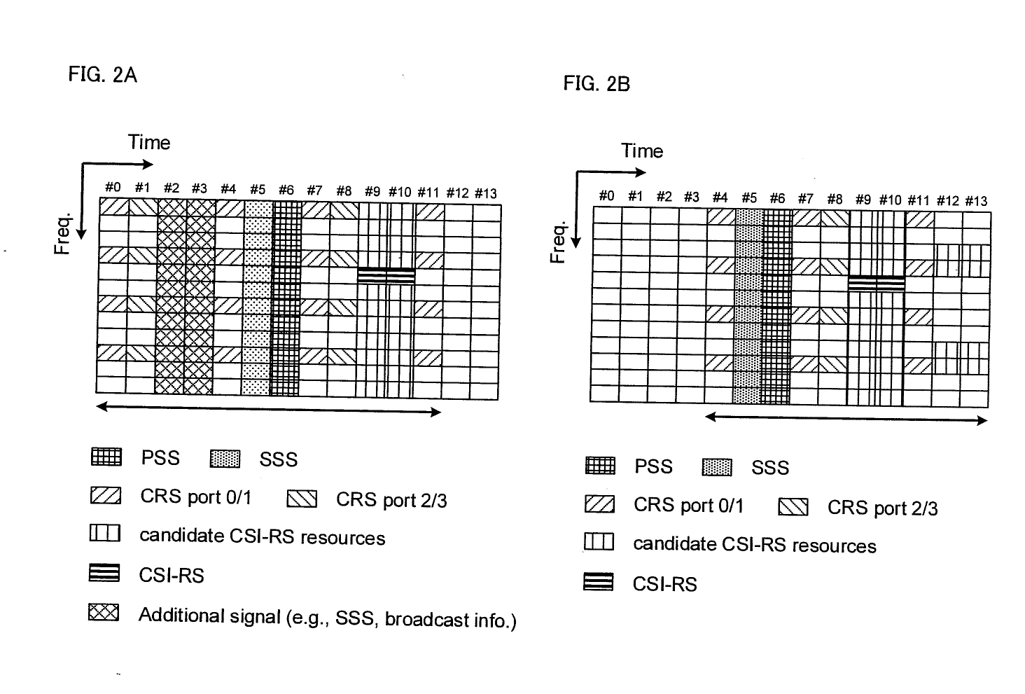

So, the present inventors have considered that it might be effective to transmit LAA DRSs that are continuous in time after LBT succeeds, and to employ a signal configuration that prevents other systems such as Wi-Fi from interrupting. FIG. 2 provide diagrams to show example configurations of DSs that are continuous in time.

FIG. 2A assumes a case where LBT is performed at the end of a subframe (in at least one of symbols #12 and #13), and the LAA DRS is transmitted in the rest of the symbols (symbol #0 to #11). Also, FIG. 2B assumes a case where LBT is performed at the beginning of a subframe (in at least one of symbols #0 to #3), and the LAA DRS is transmitted in the rest of the symbols (symbol #4 to #13).

In the LAA DRS of FIG. 2A, CRS ports 2/3 are mapped to symbols #1 and #8. Furthermore, in FIG. 2A, additional signals (for example, an SSS, broadcast information, etc.) are mapped to symbols #2 and #3. In the LAA DRS of FIG. 2B, CRS ports 2/3 are mapped to symbol #8.

However, the present inventors have found out that configuring the LAA DRS as shown in FIG. 2 will raise the following problems. To be more specific, if, as shown in FIG. 2A, the candidate CSI-RS symbols are confined within one continuous time period (symbols #9 and #10), the number of CSI-RS configurations that can be used becomes smaller, and it necessarily follows that the possibility of resource collisions between cells increases.

Also, as shown in FIG. 2B, even when candidate CSI-RS symbols (symbols #9 and #10 or symbols #12 and #13) can be assigned to a plurality of time periods, the symbol to transmit changes depending on the CSI-RS configuration used, and the continuity and the length of the DS in time cannot be maintained. For example, when CSI-RSs are mapped to symbols #9 and #10, no transmission takes place in symbols #12 and #13, which then makes the length of the DRS in time short. Furthermore, if CSI-RSs are mapped to symbols #12 and #13, the DRS becomes discontinuous in time in symbols #9 and #10.

In this way, the present inventors have considered that, with the DRS configurations that have been studied heretofore, it is not possible to map CSI-RSs flexibly, and the properties of signals that are required in cells (for example, unlicensed bands) in which listening is executed prior to transmission cannot be achieved. So, the present inventors have come up with the idea of extending the symbols (REs: Resource Elements) in the DRS, to which CSI-RSs can be mapped, in the time direction, within DRS occasions (DRS bursts).

Furthermore, the present inventors have considered that, when data is not transmitted in the DRS, data demodulation reference signals (for example, the DMRS (DeModulation Reference Signal)), downlink control information (PDCCH/EPDCCH) and so on are not necessary. Then, the present inventors have come up with the idea of mapping CSI-RSs to be included in DRSs by using configurations, in which, compared to existing CSI-RS configurations, extended symbols (or resource elements) where CSI-RSs can be mapped are provided in the resource regions of such unnecessary signals.

According to one embodiment of the present invention, it is possible to transmit CSI-RSs over a plurality of symbols within a discovery measurement signal (for example, the DRS), and maintain the length in time, the continuity in time and so on, regardless of the CSI-RS configuration. Also, since a large number of reference signal configuration patterns (resource mapping patterns) can be secured, it becomes possible to execute highly accurate CSI measurements, based on DRSs, even in cells where listening is executed prior to transmission (for example, unlicensed bands).

Now, the present embodiment will be described in detail below with reference to the accompanying drawings. Although the present embodiment will be described assuming that a carrier where listening is configured is an unlicensed band, this is by no means limiting. The present embodiment is applicable to any carriers (or cells) in which listening is configured, regardless of whether a carrier is a licensed band or an unlicensed band. Furthermore, although cases will be described with the present embodiment where small cells are used as radio base stations, this is by no means limiting.

Also, although cases will be shown in the following description where listening is employed in LTE/LTE-A systems, the present embodiment is by no means limited to this. The present embodiment is applicable to any cases where listening is executed before signals are transmitted and where channel states are estimated by using channel state information reference signals.

Furthermore, although channel state measurement reference signal configurations included in discovery signals will be described in the following description, the present embodiment is by no means limited to this, and can also be applied to channel state measurement reference signals that are transmitted based on the result of LBT without being multiplexed with data.

### FIRST EXAMPLE

With the first example, examples of reference signal configurations to apply to the channel state measurement reference signals that are included in discovery signals (that are transmitted in DRSs), and the configuration patterns (resource mapping) of these reference signals will be described.

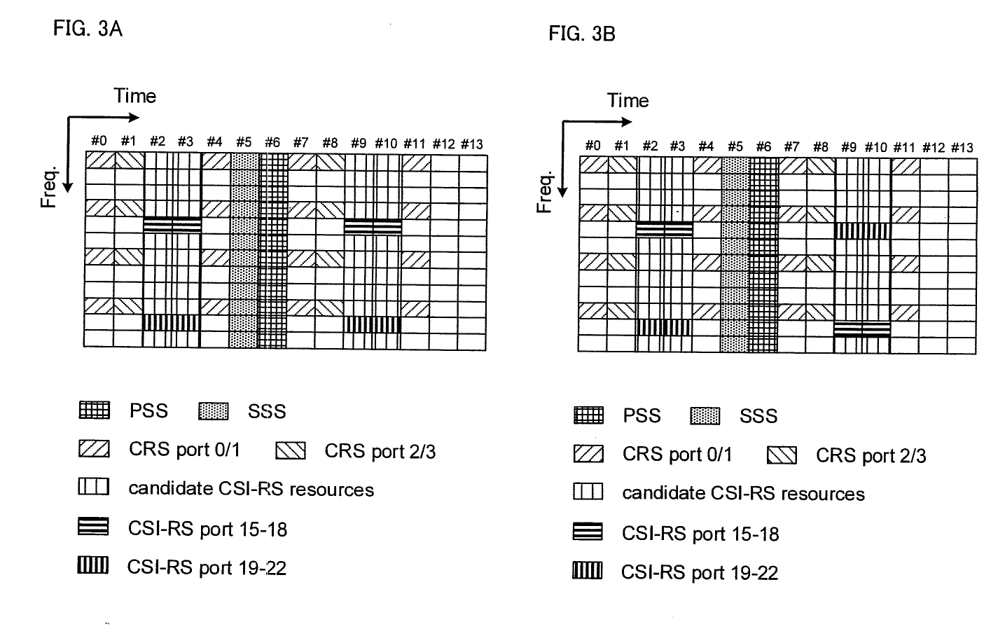

FIG. 3 shows examples of assignment of reference signal (CSI-RSs) in a DRS burst, which is transmitted after listening (LBT_{idle}). In FIG. 3, cell-specific reference signals (CRSs) are mapped to symbols #0, #1, #4, #7, #8 and #11, and synchronization signals (PSS and SSS) are mapped to symbols #5 and #6. Furthermore, symbols #2, #3, #9 and #10 are candidate regions for assigning reference signals for measuring channel states (for example, CSI-RSs). Note that the locations to assign CRSs and synchronization signals are by no means limited to these, and it is equally possible to assign other reference signals.

In FIG. 3, a radio base station maps CSI-RSs (enhanced CSI-RSs) to a first resource region (symbols #2 and #3) and a second resource region (symbols #9 and #10), which are placed to sandwich the cell-specific signals and the synchronization signals. That is, by mapping CSI-RSs (enhanced CSI-RSs) to symbols #2 and #3, in addition to symbols #9 and #10, the radio base station implements an assignment of CSI-RSs that is extended greater in the time direction than existing CSI-RSs for channel state measurements.

Note that the existing CSI-RSs for channel state measurements include, for example, the CSI-RS that is multiplexed with a downlink shared channel and/or a downlink control channel and transmitted, the CSI-RS that is include in a discovery signal that is transmitted without employing listening (in a licensed band), and so on.

Also, the radio base station can transmit enhanced CSI-RSs by using a plurality of antenna ports. For example, assume a case where the radio base station transmits CSI-RSs by using maximum eight antenna ports (for example, p=15 to 22). In this case, the radio base station can transmit CSI-RSs by using one, two, four or eight antenna ports. Furthermore, the radio base station can use port 15 (p=15) when transmitting CSI-RSs by using one antenna port, use ports 15 and 16 (p=15 and 16) when transmitting CSI-RSs by using two antenna ports, use ports 15 to 18 (p=15 to 18) when transmitting CSI-RSs by using four antenna ports, and use ports 15 to 22 (p=15 to 22) when transmitting CSI-RSs by using eight antenna ports. Note that the number of antenna ports and the antenna port numbers that can be used to transmit CSI-RSs are by no means limited to these.

When the radio base station transmits CSI-RSs using port 15, reference signal sequences that are generated are multiplied by a first orthogonal code (for example, [+1, +1, +1, +1] and mapped to symbols #2, #3, #9 and #10. Also, when the radio base station transmits CSI-RSs using port 16, reference signal sequences that are generated are multiplied by a second orthogonal code (for example, [+1, +1, −1, −1] and mapped to symbols #2, #3, #9 and #10. When the radio base station transmits CSI-RSs using port 17, reference signal sequences that are generated are to multiplied by a second orthogonal code (for example, [+1, −1, +1, −1] and mapped to symbols #2, #3, #9 and #10. Furthermore, when the radio base station transmits CSI-RSs using port 18, reference signal sequences that are generated are multiplied by a second orthogonal code (for example, [+1, −1, −1, +1] and mapped to symbols #2, #3, #9 and #10. The corresponding relationships between port numbers and orthogonal codes are not limited to these examples.

The radio base station can generate the reference signal sequences of enhanced CSI-RSs by using the same generating equation as for existing CSI-RSs. Also, ports 19 to 22 can be mapped to other frequency resources by using the same sequences/spreading codes as those of ports 15 to 18. For example, referring to FIG. 3, it is possible to apply four types of orthogonal codes (orthogonal sequences) to eight antenna ports, and, furthermore, assign antenna ports, to which the same orthogonal sequence is applied, to different frequency resources.

Also, as a method of mapping CSI-RSs that correspond to each antenna port, the radio base station can map the same antenna port to the same frequency resources in varying symbols (in the first resource region and the second resource region) (see FIG. 3A). FIG. 3A shows a case where, when predetermined antenna ports (antenna ports 15 to 18 or antenna ports 19 to 22) are mapped to the first resource region (symbols #2 and #3) and the second resource region (symbols #9 and #10), these antenna ports are mapped to the same frequency resources. In this way, by mapping the same antenna ports to the same frequency resources between symbols, for example, it becomes possible to use the same frequency resources that are distant in time, for highly accurate frequency offset correction.

Alternatively, the radio base station can map the same antenna port to different frequency resources in varying symbols (in the first resource region and the second resource region (see FIG. 3B). FIG. 3B shows a case where, when predetermined antenna ports are mapped to the first resource region and the second resource region, these antenna ports are mapped to different frequency resources. That is, in FIG. 3B, antenna ports 15 to 18 are assigned to first frequency resources in the first resource region and to second frequency resources in the second resource region, and antenna ports 19 to 22 are assigned to second frequency resources in the first resource region and to first frequency resources in the second resource region. In this way, by mapping the same antenna ports to different frequency resources between symbols, the reference signals are arranged to be distributed wider in time/frequency, so that highly accurate CSI measurements can be conducted.

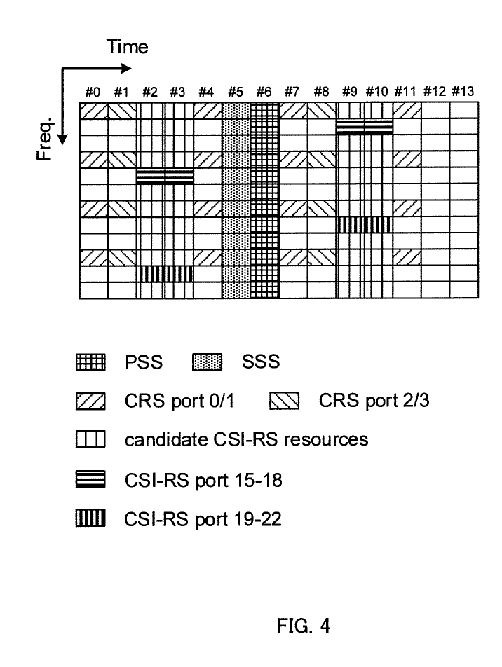

Although FIG. 3B shows a case where, when predetermined antenna ports are mapped to different frequency resources between symbols, two variations of frequency resources are used to assign antenna ports 15 to 18 and antenna ports 19 to 22, this is by no means limiting. For example, it is equally possible to assign antenna ports 15 to 18 to first frequency resources in the first resource region and to second frequency resources in the second resource region, and assign antenna ports 19 to 22 to third frequency resources in the first resource region and to fourth frequency resources in the second resource region (see FIG. 4). As shown in FIG. 4, by assigning antenna ports to a plurality of frequency resources in a distributed manner, it is possible to conduct highly accurate CSI measurements by using reference signals that are distributed wider in time/frequency, especially when eight antenna ports are used.

Furthermore, when the radio base station transmits enhanced CSI-RSs as shown in FIG. 3, it is possible to control mapping by using reference signal configurations (enhanced reference signal configurations), in which the resource regions for use for allocation (resource elements) are extended in comparison to existing CSI-RS configurations. For example, the radio base station can use all subcarriers in the first resource region (symbols #2 and #3) and the second resource region (symbols #9 and #10) as candidate CSI-RS resources.

If, as shown in FIG. 3A, existing CSI-RSs are assigned to a range of symbols #0 to #11, part of the subcarriers in symbols #9 and #10 and in symbols #5 and #6 become candidate CSI-RS resources. However, when other signals (for example, synchronization signals) are mapped to symbols #5 and #6, the candidate CSI-RS resources for existing CSI-RSs are limited to symbols #9 and #10. In this case, the number of CSI-RS configurations that can be used decreases, and therefore collisions of resources are more likely between cells.

By contrast with this, with the enhanced CSI-RSs shown in FIG. 3, it is possible to use reference signal configurations in which the resource regions (resource elements) for use for allocation are extended in comparison to existing CSI-RS configurations, so that it is possible to maintain the number of reference signal configuration patterns. As a result of this, it is possible to reduce the collisions of resources between cells. Furthermore, since reference signals that correspond to predetermined antenna ports are mapped to be extended greater in the time direction than existing CSI-RSs (for example, mapped to symbols #2, #3, #9 and #10), it is possible to maintain the length in time, the continuity in time and so on regardless of what reference signal configuration is used, and, consequently, improve the quality of channel state measurements.

<Number of Reference Signal Configuration Patterns>

Furthermore, the number of reference signal configuration patterns for CSI-RSs (the number of CSI-RS configuration patterns) according to the present embodiment can be configured to be the same as for existing CSI-RSs. For example, assuming that FDD and normal CPs (Cyclic Prefixes) are applied to existing CSI-RSs, the number of reference signal configurations is configured to 20 when the number of antenna ports is 1 or 2, the number of reference signal configurations is configured to 10 when the number of antenna ports is 4, and the number of reference signal configurations is configured to 5 when the number of antenna ports is 8.

It then follows that, when enhanced CSI-RSs (for example, CSI-RSs that are transmitted in a DRS after listening) is used, it is likewise possible to configure the number of reference signal configurations to 20 when the number of antenna ports is 1 or 2, configure the number of reference signal configurations to 10 when the number of antenna ports is 4, and the number of reference signal configurations to 5 when the number of antenna ports is 8.

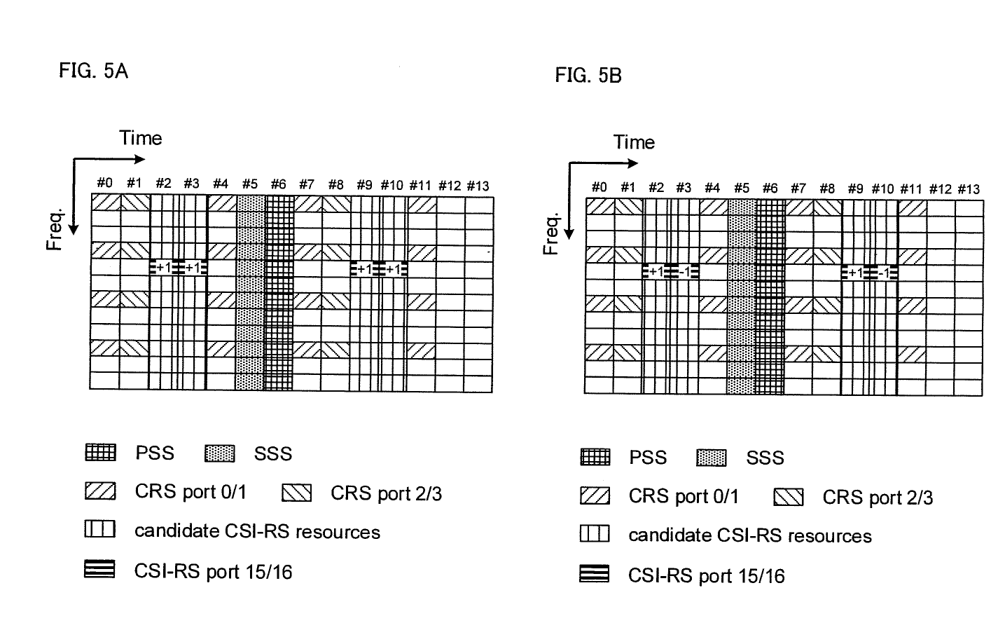

For example, when the number of antenna ports to transmit enhanced CSI-RSs is 1 or 2, it is possible to define 20 patterns of reference signal configurations by using different orthogonal sequences and/or different time/frequency resources between reference signal configurations. In this case, as shown in FIG. 5, it is possible to use a structure in which reference signal configurations (reference signal configuration indices) that are made separate reference signal configurations by using orthogonal sequences are mapped to the same resources. FIG. 5 show a case where a reference signal configuration #X, to which the orthogonal sequence [+1, +1, +1, +1] is applied (see FIG. 5A), and reference signal configuration #Y, to which the orthogonal sequence [+1, −1, +1, −1] is applied (see FIG. 5B), are mapped to the same time/frequency resources.

Furthermore, when the number of antenna ports is 4, it is possible to define 10 patterns of reference signal configurations by using different time/frequency resources between reference signal configurations. In this case, a different orthogonal sequence (four types of orthogonal sequence in all) can be applied to every antenna port. Likewise, when the number of antenna ports is 8, it is possible to apply a different orthogonal sequence (four types of orthogonal sequence in all) to every antenna port, and, furthermore, define 5 patterns of reference signal configurations by using different time/frequency resources between reference signal configurations.

In this way, by defining the reference signal configurations (indices) of enhanced CSI-RSs like the number of reference signal configurations (indices) for existing CSI-RS is defined, common report reference signal configurations (indices) can be configured and reported to a user terminal. In this case, based on the type of reference signals received (for example, existing CSI-RSs, CSI-RSs included in DRSs, etc.), the user terminal can presume different reference signal configurations and control the receiving operation accordingly. Note that, the radio base station may report information about the reference signal configurations (indices) of enhanced CSI-RSs and information about the reference signal configurations (indices) of existing CSI-RSs, to the user terminal. Furthermore, it is also possible to configure the number of reference signal configuration patterns for enhanced CSI-RSs greater than the number of reference signal configuration patterns for existing CSI-RSs.

### SECOND EXAMPLE

With a second example, other examples of the reference signal configurations to apply to CSI-RSs that are included in DRSs, and the configuration patterns (resource mapping) of these reference signals will be described. Note that, since the second example pertains to a reference signal mapping method that is different from the first example, only parts that are different from the first example will be described below.

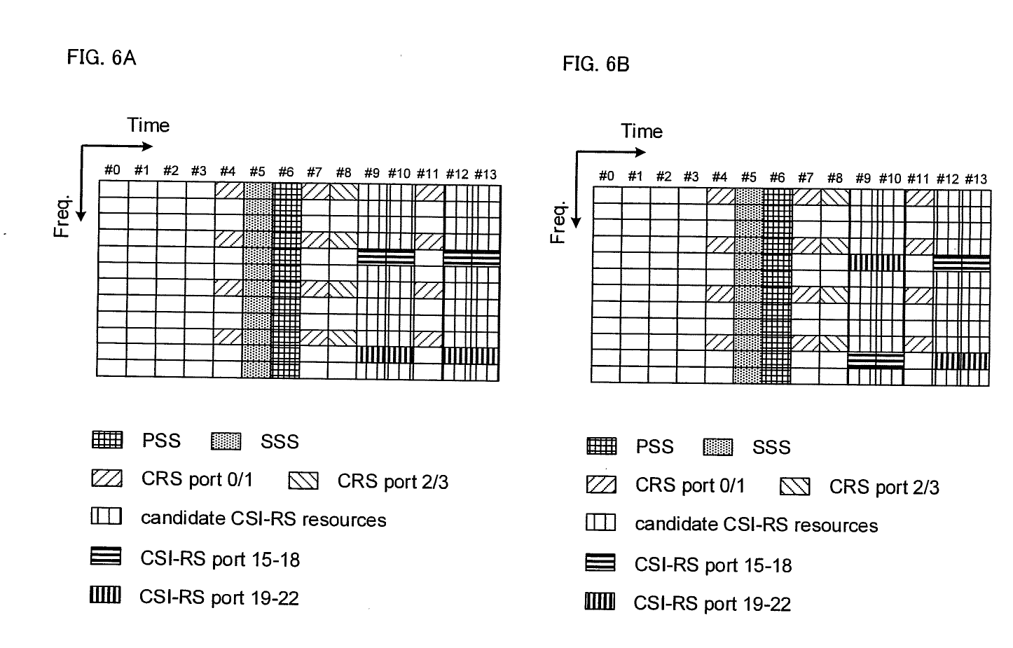

FIG. 6 show examples of assignment of reference signals in a DRS burst transmitted after listening (LBT_{idle}). FIG. 6 shows cases where cell-specific reference signals (CRSs) are mapped to symbols #4, #7, #8 and #11, and synchronization signals (PSS and SSS) are mapped to symbols #5 and #6. Furthermore, symbols #9, #10, #12 and #13 are candidate regions for assigning reference signals for channel state measurements (for example, CSI-RSs). Note that the locations to assign CRSs and synchronization signals are not limited to these, other reference signal can be assigned as well.

In FIG. 6, the radio base station maps CSI-RSs (enhanced CSI-RSs) to a first resource region (symbols #9 and #10) and a second resource region (symbols #12 and #13), which are arranged to sandwich the cell-specific signals. That is, by mapping CSI-RSs (enhanced CSI-RSs) to symbols #9, #10, #12 and #13, the radio base station implements an assignment of CSI-RSs that is extended greater in the direction of time than existing CSI-RSs.

When the radio base station transmits CSI-RSs using port 15, reference signal sequences that are generated are multiplied by a first orthogonal code (for example, [+1, +1, +1, +1] and mapped to symbols #9, #10, #12 and #13. Also, when the radio base station transmits CSI-RSs using port 16, reference signal sequences that are generated are multiplied by a second orthogonal code (for example, [+1, +1, −1, −1] and mapped to symbols #9, #10, #12 and #13. When the radio base station transmits CSI-RSs using port 17, reference signal sequences that are generated are multiplied by a second orthogonal code (for example, [+1, −1, +1, −1] and mapped to symbols #9, #10, #12 and #13. Furthermore, when the radio base station transmits CSI-RSs using port 18, reference signal sequences that are generated are multiplied by a second orthogonal code (for example, [+1, −1, −1, +1] and mapped to symbols #9, #10, #12 and #13.

The radio base station can generate the reference signal sequences of enhanced CSI-RSs by using the same generating equation as for existing CSI-RSs. Also, ports 19 to 22 can be mapped to other frequency resources by using the same sequences/spreading codes as those of ports 15 to 18. For example, referring to FIG. 6, it is possible to apply four types of orthogonal sequences to eight antenna ports, and, furthermore, assign antenna ports, to which the same orthogonal sequence is applied, to different frequency resources.

Also, as a method of mapping CSI-RSs that correspond to each antenna port, the radio base station can map the same antenna port to the same frequency resources in varying symbols (in the first resource region and the second resource region) (see FIG. 6A). FIG. 3A shows a case where, when predetermined antenna ports (antenna ports 15 to 18 or antenna ports 19 to 22) are mapped to the first resource region (symbols #9 and #10) and the second resource region (symbols #12 and #12), these antenna ports are mapped to the same frequency resources. In this way, by mapping the same antenna ports to the same frequency resources between symbols, for example, it becomes possible to use the same frequency resources that are distant in time, for highly accurate frequency offset correction.

Alternatively, the radio base station can map the same antenna port to different frequency resources in varying symbols (in the first resource region and the second resource region (see FIG. 6B). FIG. 6B shows a case where, when predetermined antenna ports are mapped to the first resource region and the second resource region, these antenna ports are mapped to different frequency resources. That is, in FIG. 6B, antenna ports 15 to 18 are assigned to second frequency resources in the first resource region and to first frequency resources in the second resource region, and antenna ports 19 to 22 are assigned to first frequency resources in the first resource region and to second frequency resources in the second resource region. In this way, by mapping the same antenna ports to different frequency resources between symbols, the reference signals are arranged to be distributed wider in time/frequency, so that highly accurate CSI measurements can be conducted.

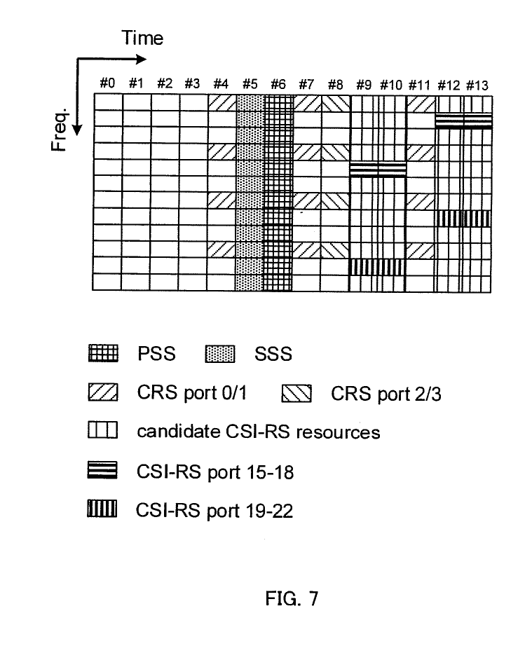

Although FIG. 6B shows a case where, when the same antenna ports are mapped to different frequency resources between symbols, two variations of frequency resources are used to assign antenna ports 15 to 18 and antenna ports 19 to 22, this is by no means limiting. For example, it is equally possible to assign antenna ports 15 to 18 to first frequency resources in the first resource region and to second frequency resources in the second resource region, and assign antenna ports 19 to 22 to third frequency resources in the first resource region and to fourth frequency resources in the second resource region (see FIG. 7). As shown in FIG. 7, by assigning antenna ports to a plurality of frequency resources in a distributed manner, it is possible to conduct highly accurate CSI measurements by using reference signals that are distributed wider in time/frequency, especially when eight antenna ports are used.

Furthermore, when the radio base station transmits enhanced CSI-RSs as shown in FIG. 6, it is possible to control mapping by using reference signal configurations (enhanced reference signal configurations), in which the resource regions for use for allocation (resource elements) are extended in comparison to existing CSI-RS configurations. For example, the radio base station can use all subcarriers in the first resource region (symbols #9 and #10) and the second resource region (symbols #12 and #13) as candidate CSI-RS resources.

If, as shown in FIG. 6, existing CSI-RSs are allocated in a range of symbols #4 to #13, part of the subcarriers in symbols #9 and #10 and in symbols #12 and #13 become candidate CSI-RS resources. However, existing CSI-RSs assume reference signal configurations in which only part of the carriers in one of the first region (symbols #9 and #10) and the second region (symbols #12 and #13) can be allocated. Consequently, depending on the reference signal configuration the radio base station employs, the assignment of existing CSI-RSs might change.

For example, when CSI-RSs are assigned to the second region (symbols #12 and #13), it is not possible to assign CSI-RSs to the first region (symbols #9 and #10). In this case, the continuity of reference signals in time and their time lengths in DRSs cannot be maintained. Also, when a region in which no reference signals are transmitted is configured, this might raise the fear that signals are transmitted from other systems having judged upon LBT_{idle} and result in collisions.

By contrast with this, with the enhanced CSI-RSs shown in FIG. 7, it is possible to use reference signal configurations in which the resource regions (resource elements) for use for allocation are extended in comparison to existing CSI-RS configurations, it is possible to maintain the continuity of reference signals in time and their time lengths in DRSs. By this means, it is possible to improve the quality of channel state measurements, and, furthermore, reduce the collisions with signals transmitted from other systems.

### THIRD EXAMPLE

With a third example, an example of the way a user terminal operates when reference signal configurations, in which extended resource regions are available for allocation in comparison to existing CSI-RS configurations, are used will be described.

As has been shown above with the first example and the second example, when a reference signal configuration, in which extended resource regions are available for allocation in comparison to existing CSI-RS configuration, is employed, it is possible report the reference signal configurations for existing CSI-RSs (for example, the resource configuration, the subframe offset, the cycle, the cell ID, the scrambling ID, etc.) and the reference signal configurations for enhanced CSI-RSs, separately, to a user terminal.

Meanwhile, reporting two reference signal configurations to a user terminal entails increased overhead, so that from the perspective of keeping the overhead low, it may be possible to report a common (for example, one) reference signal configuration to the user terminal. In this case, depending on what type of reference signals are received (for example, existing CSI-RSs, CSI-RSs include in a DRS, and so on), the user terminal may presume different reference signal configurations and control the receiving operation accordingly.

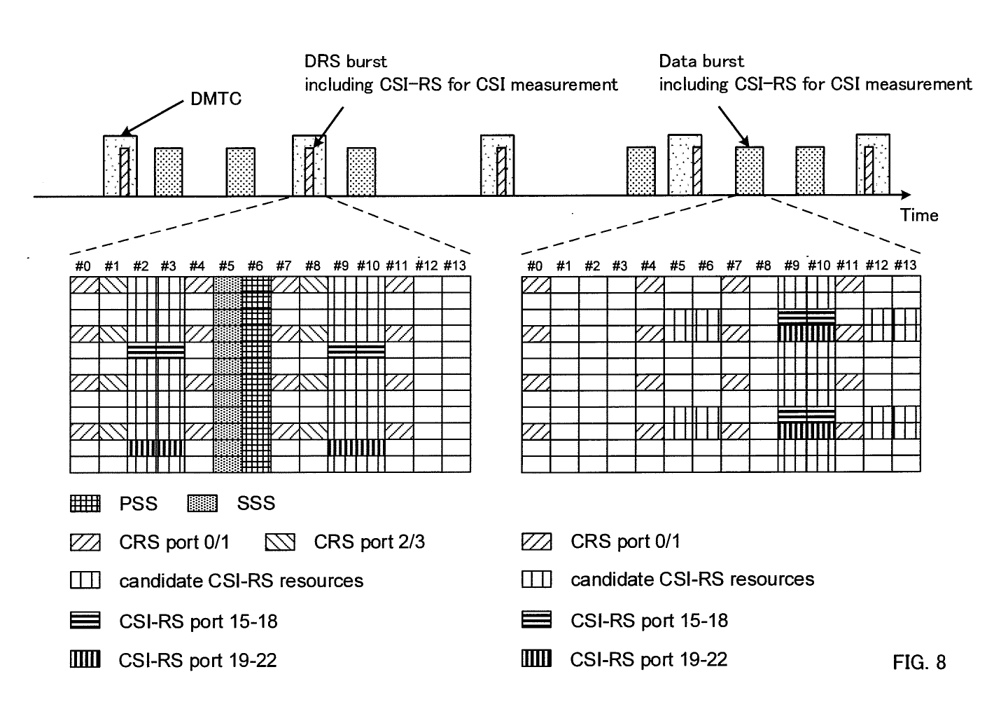

Now, a case in which a user terminal, to which CSI-RS configuration information is reported in advance, receives CSI-RSs inside DRS bursts and outside DRS bursts (for example, when CSI-RSs are multiplexed with data (PDSCH) and transmitted), will be described below with reference to FIG. 8.

The radio base station reports information about the CSI-RS configuration (for example, the resource configuration, the subframe offset, the cycle, the cell ID, the scrambling ID, etc.) to the user terminal, in advance, by higher layer signaling and so on. Furthermore, the radio base station reports information about DRS measurement timings (DMTC: Discovery Measurement Timing Configuration) to the user terminal, in advance, by higher layer signaling and so on.

Using the CSI-RS configuration-related information reported, the user terminal measures channel states based on the existing CSI-RS configurations. Meanwhile, the user terminal tries to detect burst DRS transmission in the reported DRS measurement timings (DMTC), and, if burst DRS transmission is detected, the user terminal assumes that a reference signal configuration (enhanced CSI-RS reference signal configuration) that is different from existing CSI-RS configurations is used. In this case, the user terminal can control the receiving operation based on the CSI-RS resource configuration for enhanced CSI-RSs, regardless of the subframe offset, the cycle and so on provided in the CSI-RS configuration that is prepared in advance. Note that the scrambling ID, the cell ID and so on provided in the CSI-RS configuration-related information can be applied to enhanced CSI-RSs as well.

In this way, even when a CSI-RS resource configuration during burst DRS transmission and a CSI-RS resource configuration outside burst DRS transmission bear the same index, the user terminal can assume that the actual CSI-RS resource mapping is configured differently, and control the receiving operation accordingly.

Note that, when information about a reference signal configuration for an existing CSI-RS and a reference signal configuration for an enhanced CSI-RS is reported to a user terminal as common information, it is possible to make only part of the information common information and transmit different pieces of information.

### FOURTH EXAMPLE

With a fourth example, the method of setting up the DMTC, the CSI-RS configuration and so on when a plurality of cells that employ listening are configured for a user terminal will be described.

When a plurality of cells that employ listening (for example, unlicensed bands) are configured for a user terminal, it is possible to apply a DMTC and/or a CSI-RS configuration that are common between these multiple CCs to the user terminal. While, in existing systems, the DMTC and the CSI-RS configuration are configured separately, on a per CC basis, it may be possible to reduce the overhead by applying a common configuration (for example, one configuration) to a plurality of CCs.

For example, while there are a first set of configurations (also referred to as “configuration set”) that is set up in the user terminal and a second set of configurations that is set up per CC, it is also possible to define a third set of configurations that can be applied to all the CCs that require listening, and include the DMTC, the CSI-RS configuration and so on in this third configuration set.

Alternatively, instead of applying a common configuration to all unlicensed bands, it is also possible to apply a common configuration to part of the bands (CCs), or apply a separate configuration to every CC.

When a common set of reference signal configurations is applied to a plurality of CCs that employ listening, the user terminal may report information about its compatibility/incompatibility with the reference signal configuration set (whether or not the user terminal supports the reference signal configuration set) to the network (for example, a radio base station) as capability information (UE capability). Based on the capability information reported from each user terminal, the radio base station can control the reference signal configuration to apply to each user terminal.

### FIFTH EXAMPLE

With a fifth example the CSI-RS configuration (CSI-RS resource configuration) that is applied to the DRS when the DRS and DL data (for example, the PDSCH) are multiplexed during the DRS measurement period (for example, the DMTC) will be described.

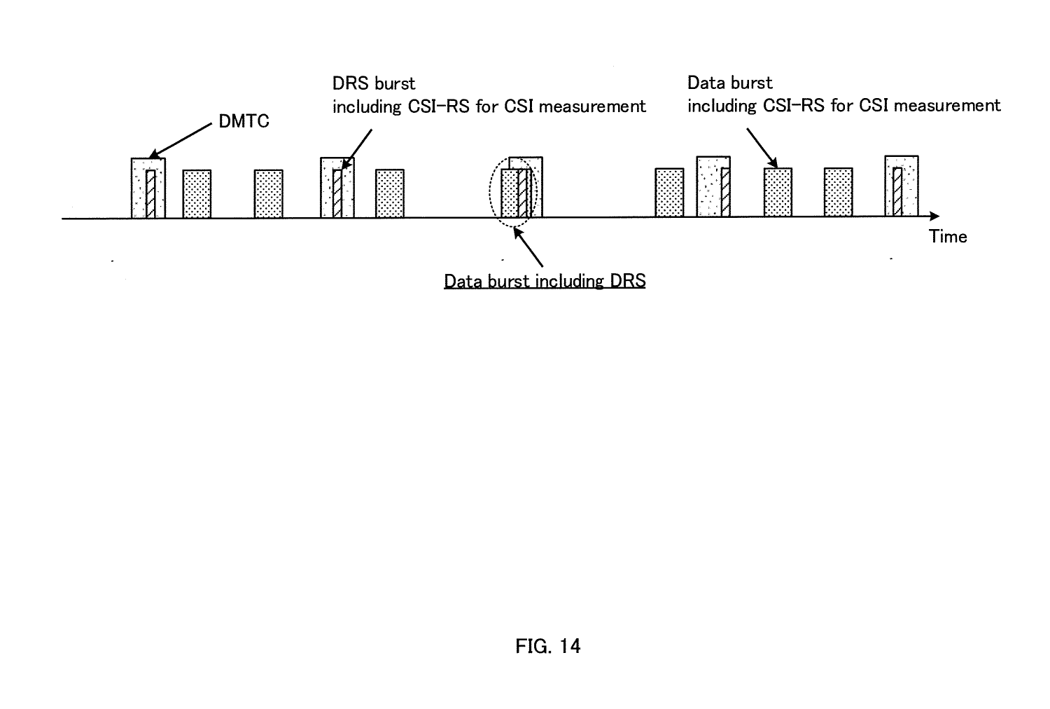

FIG. 14 shows an example case where burst transmission of DL data (for example, the PDSCH) and burst DRS transmission are carried out separately. First, assume the case where a DRS is transmitted in the DMTC without being multiplexed with the PDSCH. In this case, CSI-RS configuration information is reported form the radio base station, and a user terminal can presume different CSI-RS patterns (resource mapping) between inside and outside of DRS bursts (for example, between burst DRS transmission and burst DL data transmission) (see above FIG. 8).

By contrast with this, the case where the DRS and the PDSCH are multiplexed and transmitted in the DMTC is also likely. In this case, how to control the CSI-RS configuration in the DRS is the problem. So, the present inventors have come up with the idea of applying one of the following three patterns of CSI-RS configurations (CSI-RS configurations 1 to 3) to the DRS when the DRS and the PDSCH are multiplexed.

(CSI-RS Configuration 1)

With CSI-RS configuration 1, a new CSI-RS configuration (CSI-RS resource configuration) for the DRS is applied to the DRS that is multiplexed with DL data in the DMTC. For example, the CSI-RS configuration (for example, the CSI-RS configuration in the left DRS in FIG. 8) to apply to the DRS when burst DRS transmission is carried out without multiplexing with DL data is also applied to the DRS that is multiplexed with DL data transmission in the DMTC. The CSI-RS configuration in this case is different from the CSI-RS configuration that is used upon DL data transmission, so that a new rate matching pattern needs to be defined when the PDSCH is used.

The user terminal can identify the pattern of the CSI-RS configuration based on whether or not it is inside the DMTC duration. Also, as for the method of detecting the locations of CSI-RSs in the DRS, the user terminal can assume that CSI-RSs are arranged in the same subframe with the DRS (for example, the PSS/SSS), and perform the receiving processes accordingly.

(CSI-RS Configuration 2)

With CSI-RS configuration 2, an existing CSI-RS configuration is used for the DRS that is multiplexed with DL data in the DMTC. For example, the CSI-RS configuration to apply to DL data transmission (for example, the CSI-RS configuration for DL data transmission shown on the right in FIG. 8) is also applied to the DRS that is multiplexed with DL data transmission in the DMTC. The CSI-RS configuration in this case is the same as the CSI-RS configuration that is used upon DL data transmission, so that an existing rate matching pattern can be used. Also, CSI-RS configurations to result in the synchronization signals (PSS/SSS) included in the DRS are controlled not to be used.

The user terminal can identify the pattern of the CSI-RS configuration pattern by detecting whether or not the DRS is multiplexed with the PDSCH in the DMTC duration. For example, when the user terminal detects the DRS in the DMTC, the user terminal can judge whether or not the PDSCH is multiplexed in the same subframe by detecting predetermined control information (for example, the PDCCH, the PCFICH, etc.).

(CSI-RS Configuration 3)

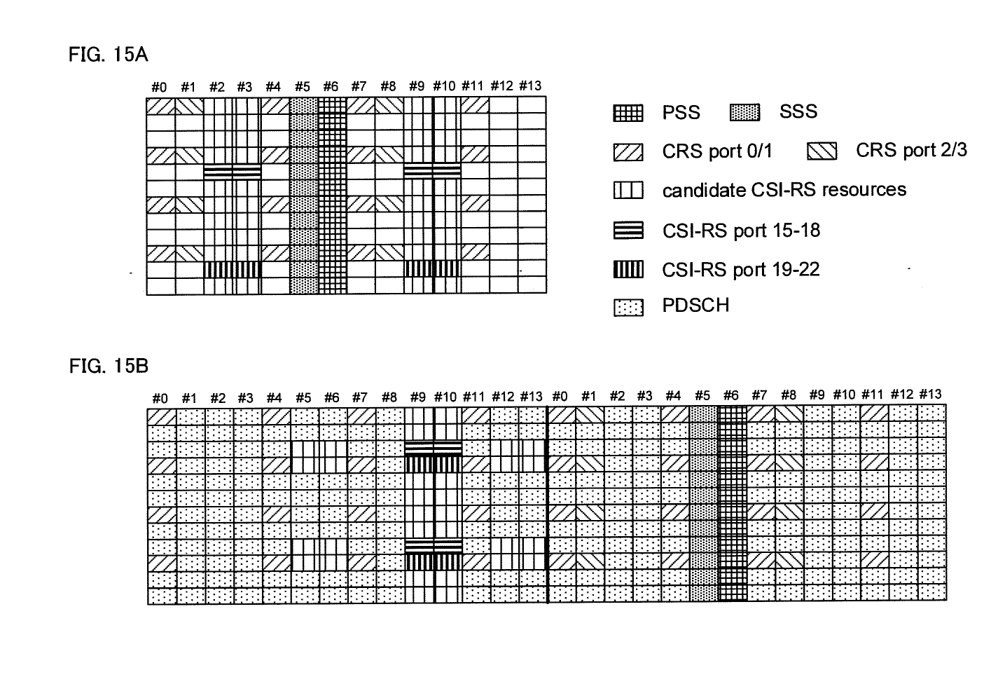

With CSI-RS configuration 3, a configuration to transmit CSI-RSs in different transmission time intervals (TTIs) from the TTIs in which synchronization signals (PSS/SSS) and CRSs are included (see FIG. 15) is used for the DRS that is multiplexed with DL data in the DMTC. Note that, the DRS TTIs to include synchronization signals (PSS/SSS) and CRSs can be, for example, subframes.

FIG. 15 show examples of CSI-RS configurations in DRSs in CSI-RS configuration 3. When the DRS and the PDSCH are not multiplexed in the DMTC, a new CSI-RS configuration for DRS can be used (see FIG. 15A). On the other hand, when the DRS and the PDSCH are multiplexed in the DMTC, it is possible to form the DRS with a TTI (subframe) that includes synchronization signals and CRSs and a TTI that includes CSI-RSs (see FIG. 15B).

FIG. 15B show a case where a DRS is arranged over two subframes, and where CSI-RSs are arranged in the first-half subframe and synchronization signals and CRSs are assigned to the second-half subframe. An existing CSI-RS configuration can be used for the CSI-RS configuration in the first-half subframe. Note that the configuration of the DRS in CSI-RS configuration 3 is not limited to that illustrated in FIG. 15B. It is equally possible to make the second-half subframe the subframe to allocate CSI-RSs, or assign CSI-RSs and synchronization signals to discontinuous subframes.

Furthermore, when CSI-RS configuration 3 is applied, the DRS configuration changes depending on whether or not the DRS is multiplexed with the PDSCH. For example, when the DRS is transmitted in the DMTC without being multiplexed with the PDSCH (see FIG. 15A), the DRS configuration is less than 1 ms, and, when the DRS is multiplexed with the PDSCH and transmitted (see FIG. 15B), the DRS configuration becomes a number of subframes (for example, 2 ms). Consequently, the user terminal needs to detect whether or not the DRS and the PDSCH are multiplexed, and, furthermore, learn the locations of CSI-RSs when the DRS and the PDSCH are multiplexed.

For example, when the user terminal detects a DRS in the DMTC, the user terminal can judge whether or not the PDSCH is multiplexed in the same subframe by detecting predetermined control information (for example, the PDCCH, the PCFICH, etc.). Furthermore, the user terminal can judge the locations of CSI-RSs based on information about subframe offset (subframeOffset-r12) reported in a DRS configuration that is defined in an existing system (Rel. 12).

In this way, collisions between synchronization signals (PSS/SSS) and CSI-RSs can be prevented by employing CSI-RS configuration 3. Also, when CSI-RS configuration 3 is employed, the PDSCH is not multiplexed on the new CSI-RS configuration for DRS, so that it is not necessary to define a new rate matching pattern.

Furthermore, in a DRS configuration of an existing system (Rel. 12), information about the length of burst DRS transmission (ds-OccationDuration) is reported to a user terminal in the DMTC (6 ms). When interpreting and using information about the existing system's DRS configuration, the user terminal can apply the information reported as ds-OccationDuration only to DRS configurations in which the PDSCH is multiplexed (see FIG. 15B). When a DRS is transmitted without being multiplexed with a PDSCH (see FIG. 15A), the user terminal can judge that the DRS configuration is shorter than 1 ms, regardless of what information is reported as ds-OccationDuration.

<Interpretation of CSI-RS Configuration Information>

Furthermore, the user terminal reads and interprets the information about the CSI-RS configuration, reported from the radio base station (CSI-RS configuration information (for example, CSI-RS-ConfigNZP)) based on the mode of transmission (burst DRS transmission or burst data transmission).

For example, the user terminal interprets that information about CSI-RS antenna ports (antennaPortsCount-r11), information about scrambling (scramblingIdentity-r11) and information about transmission points (qcl-CRS-Info-r11) are common between burst DRS transmission and burst data transmission.

Meanwhile, as for information about resource configurations (resourceConfig-r11), the user terminal interprets that different resource configurations are used, depending on the mode of transmission, even when they bear the same index. For example, even though the same index is assigned, different resource configurations are applied between burst data transmission (DRS bursts not multiplexed with DL data (CSI-RS configurations 2 and 3) and burst DRS transmission that is not multiplexed with DL data.

Furthermore, the user terminal can apply information related to subframes (subframeConfig-r11) only to CSI-RSs in burst data transmission. That is, the user terminal does not apply the information about subframes to burst DRS transmission that is not multiplexed with DL data.

In this way, by reading and interpreting information about the CSI-RS configuration based on the mode of transmission (burst DRS transmission or burst data transmission), it is possible to reduce the information to transmit to user terminals.

### SIXTH EXAMPLE

A case will be described with a sixth example where broadcast information is transmitted in a DRS (for example, a DRS and broadcast information are multiplexed in the same subframe).

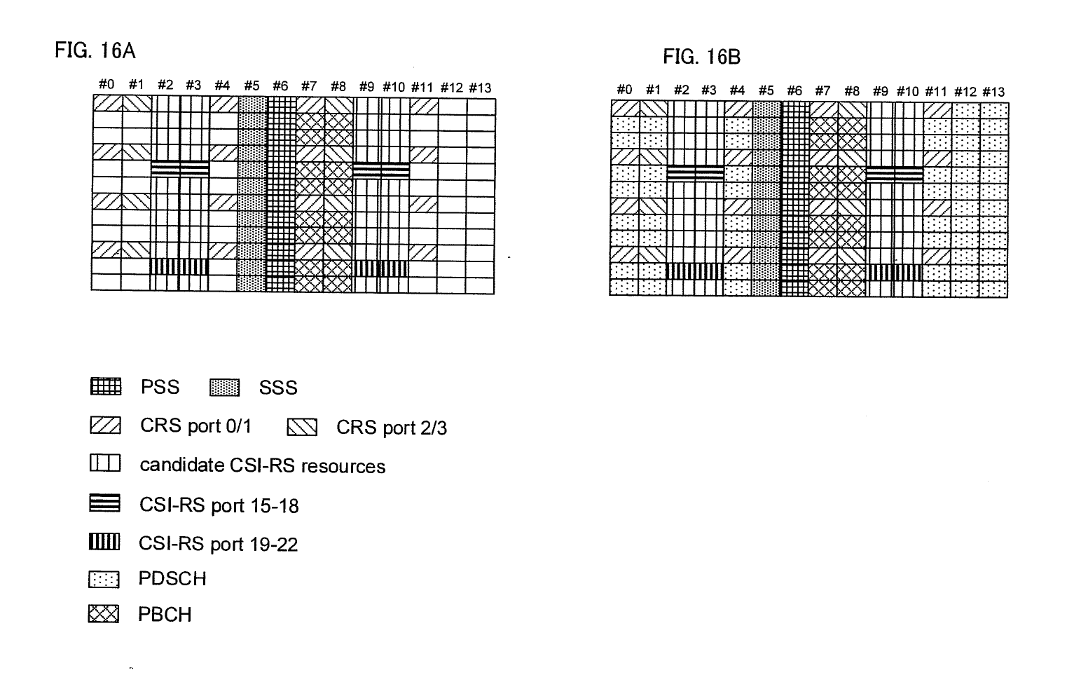

When broadcast information (PBCH) is mapped in a DRS, it is possible to employ a structure in which the broadcast information is multiplexed on symbols #7 and #8 among the central six RBs in the system band (for example, in two symbols at the top of the second-half slot) (see FIG. 16). FIG. 16A is a diagram to show an example of the method of multiplexing a DRS and broadcast information, used when the DRS is transmitted without being multiplexed with DL data. FIG. 16B show an example method of multiplexing a DRS, broadcast information and a PDSCH, used when the DRS is multiplexed with DL data and transmitted. Note that the number of symbols where the PBCH can be multiplexed is not limited to this.

In this way, by multiplexing broadcast information on predetermined symbols in the central six RBs in the system band as in existing systems, a user terminal can re-use the rate matching for the existing PBCH.

(Structure of Radio Communication System)

Now, the structure of the radio communication system according to an embodiment of the present invention will be described below. In this radio communication system, the radio communication methods according to the embodiment of the present invention are employed. Note that the radio communication methods of the above-described examples may be applied individually or may be applied in combination.

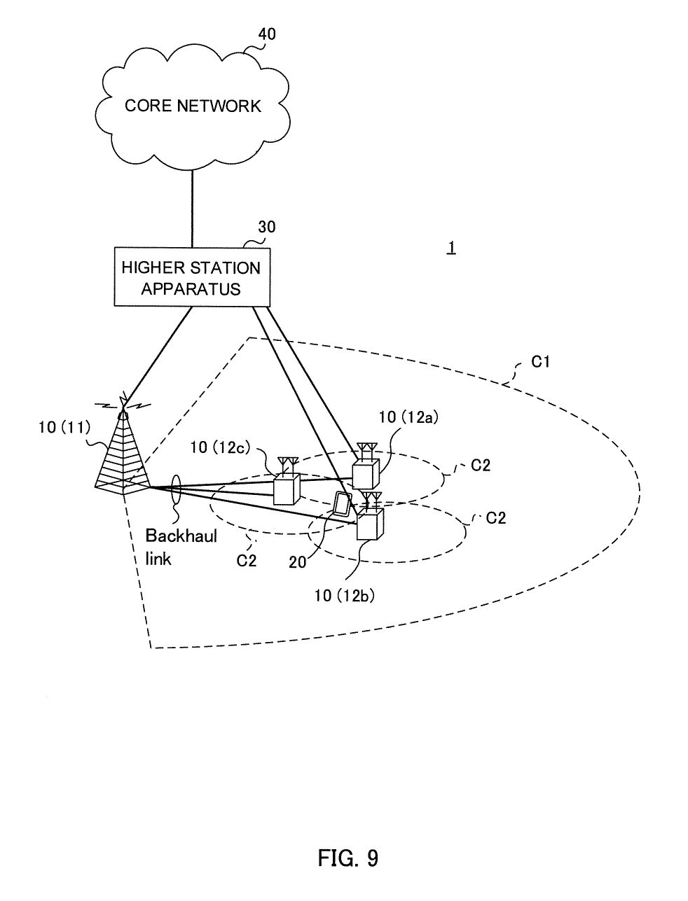

FIG. 9 is a diagram to show an example of a schematic structure of a radio communication system according to an embodiment of the present invention. Note that the radio communication system shown in FIG. 9 is a system to incorporate, for example, an LTE system, super 3G, an LTE-A system and so on. In this radio communication system, carrier aggregation (CA) and/or dual connectivity (DC) to bundle multiple component carriers (CCs) into one can be used. Also, these multiple CCs include licensed band CCs that use licensed bands and unlicensed band CCs that use unlicensed bands. Note that this radio communication system may be referred to as “IMT-Advanced,” or may be referred to as “4G,” “5G,” “FRA” (Future Radio Access) and so on.

The radio communication system 1 shown in FIG. 9 includes a radio base station 11 that forms a macro cell C1, and radio base stations 12 (12a to 12c) that form small cells C2, which are placed within the macro cell C1 and which are narrower than the macro cell C1. Also, user terminals 20 are placed in the macro cell C1 and in each small cell C2.

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can execute CA by using at least two CCs (cells), or use six or more CCs.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Between the radio base station 11 and the radio base stations 12 (or between two radio base stations 12), wire connection (optical fiber, the X2 interface, etc.) or wireless connection may be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs, (Master Information Blocks) and so on are communicated by the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH may be frequency-division-multiplexed with the PDSCH (downlink shared data channel) and used to communicate DCI and so on, like the PDCCH.

Also, as downlink reference signals, cell-specific reference signals (CRSs), channel state measurement reference signals (CSI-RSs: Channel State Information-Reference Signals), user-specific reference signals (DM-RSs: Demodulation Reference Signals) for use for demodulation, and other signals are included.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH. Also, downlink radio quality information (CQI: Channel Quality Indicator), delivery acknowledgment signals (HARQ-ACKs) and so on are communicated by the PUCCH. By means of the PRACH, random access preambles (RA preambles) for establishing connections with cells are communicated.

<Radio Base Station>

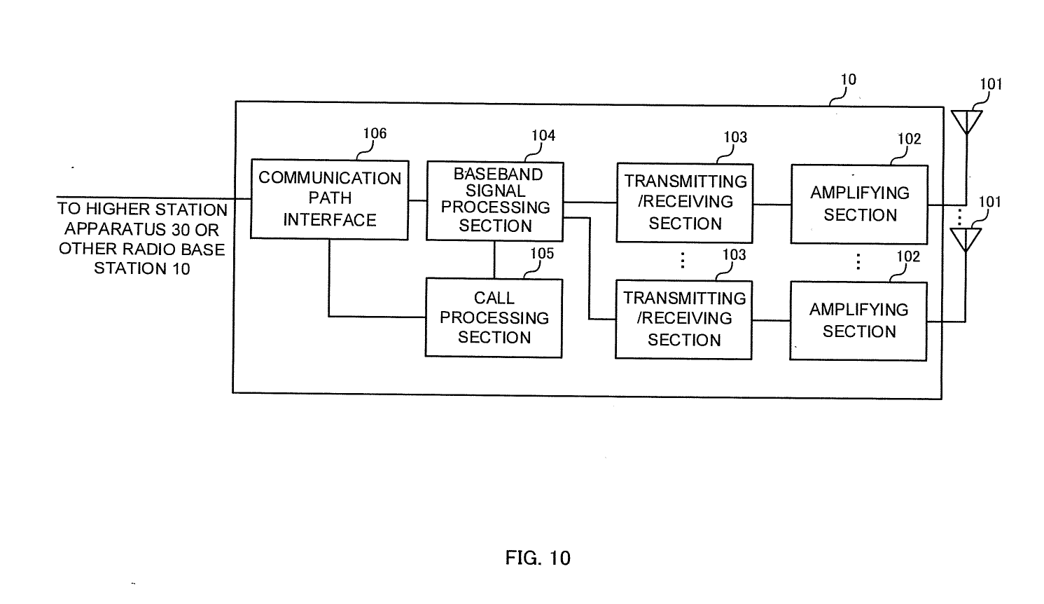

FIG. 10 is a diagram to show an example of an overall structure of a radio base station according to an embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that the transmitting/receiving sections 103 are comprised of transmission sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency band. The radio frequency signals subjected to frequency conversion in the transmitting/receiving sections 103 are amplified in the amplifying sections 102, and transmitted from the transmitting/receiving antennas 101.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

For example, the transmitting/receiving sections (transmitting sections) 103 can transmit a discovery signal that includes first reference signals for measuring channel states (for example, enhanced CSI-RSs) based on the result of listening. Also, the transmitting/receiving sections (transmitting sections) 103 can transmit the first reference signals by using predetermined antenna ports (for example, antenna ports 15 to 22). Furthermore, the transmitting/receiving sections (transmitting sections) 103 can transmit information about a discovery signal configuration and/or a channel state measurement reference signal configuration that are configured in common in a plurality of cells to a user terminal to user terminals. For the transmitting/receiving sections 103, transmitters/receivers, transmitting/receiving circuits or transmitting/receiving devices that can be described based on common understanding of the technical field to which the present invention pertains can be used.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. The communication path interface 106 transmits and receives signals to and from neighboring radio base stations 10 (backhaul signaling) via an inter-base station interface (for example, optical fiber, the X2 interface, etc.).

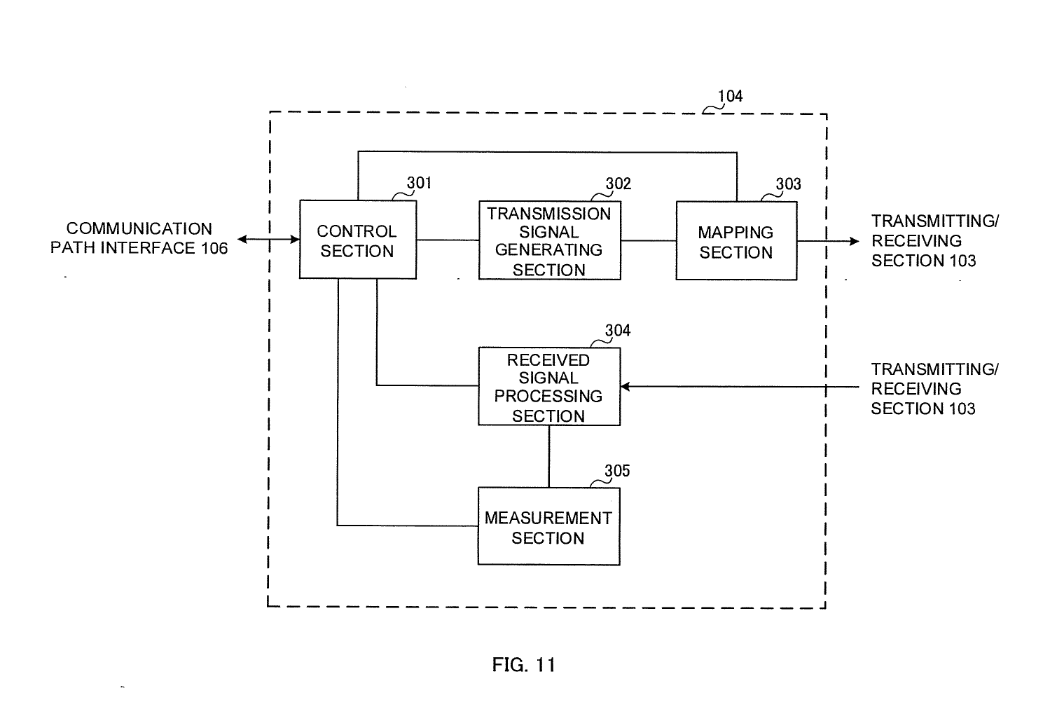

FIG. 11 is a diagram to show an example of a functional structure of a radio base station according to the present embodiment. Note that, although FIG. 11 primarily shows functional blocks that pertain to characteristic parts of the present embodiment, the radio base station 10 has other functional blocks that are necessary for radio communication as well. As shown in FIG. 11, the baseband signal processing section 104 has a control section (scheduler) 301, a transmission signal generating section (generating section) 302, a mapping section 303, a received signal processing section 304 and a measurement section 305.

The control section (scheduler) 301 controls the scheduling (for example, resource allocation, mapping and so on) of downlink data that is transmitted in the PDSCH and downlink control information that is communicated in the PDCCH and/or the EPDCCH. Furthermore, the control section (scheduler) 301 also controls the scheduling (for example, resource allocation, mapping and so on) of system information, synchronization signals, paging information, CRSs, CSI-RSs, discovery signals and so on.

Also, the control section 301 controls the scheduling of uplink reference signals, uplink data signals that are transmitted in the PUSCH, uplink control signals that are transmitted in the PUCCH and/or the PUSCH, random access preambles that are transmitted in the PRACH, and so on. Furthermore, the control section 301 can control the first reference signals for channel state measurements, included in discovery signals, to be extended greater in the time direction than existing second reference signals for channel state measurements.

Furthermore, the control section 301 can control the assignment of first reference signals by using reference signal configurations, in which extended resource regions are configured for use for allocation, in comparison to the reference signal configurations applied to second reference signals. When synchronization signals and cell-specific reference signals are further included in a discovery signal, the control section 301 can assign first reference signals to a first resource region and a second resource region, which are arranged to sandwich the synchronization signals and/or the cell-specific signals (see FIG. 3, FIG. 6, etc.).

Furthermore, the control section 301 can assign first reference signals that correspond to predetermined antenna ports to the same frequency resources or to different frequency resources in the first resource region and the second resource region (see FIG. 3, FIG. 4, FIG. 6 and FIG. 7).

Furthermore, the control section 301 can apply a number of (four example, four patterns of) orthogonal sequences, matching the number of symbols where enhanced CSI-RSs are mapped, to a plurality of antenna ports (for example, eight antenna ports), and control antenna ports, to which the same orthogonal sequence is applied, to be assigned to different frequency resources. Also, the control section 301 controls the transmission of DL signals (DL data, discovery signals, etc.) based on the result of listening (DL-LBT).

Note that, for the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DL assignments, which report downlink signal assignment information, and UL grants, which report uplink signal assignment information, based on commands from the control section 301. Note that, for the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 (for example, synchronization signals, cell-specific reference signals, discovery signals including channel state measure reference signals, and so on) to predetermined radio resources, based on commands from the control section 301, and outputs these to the transmitting/receiving sections 103. Note that, for the mapping section 303, mapper, a mapping circuit or a mapping device that can be described based on common understanding of the technical field to which the present invention pertains can be used.

The receiving process section 304 performs receiving processes (for example, demapping, demodulation, decoding and so on) of UL signals (for example, delivery acknowledgement signals (HARQ-ACKs), data signals that are transmitted in the PUSCH, and so on) transmitted from the user terminals. The processing results are output to the control section 301. The received signal processing section 304 can be constituted by a signal processor, a signal processing circuit or a signal processing device that can be described based on common understanding of the technical field to which the present invention pertains.

Also, by using the received signals, the measurement section 305 may measure the received power (for example, the RSRP (Reference Signal Received Power)), the received quality (for example, the RSRQ (Reference Signal Received Quality)), channel states and so on. Also, upon listening before DL signal transmission in unlicensed bands, the measurement section 305 can measure the received power of signals transmitted from other systems and/or the like. The results of measurements in the measurement section 305 are output to the control section 301. The control section 301 can control the transmission of DL signals based on measurement results (listening results) in the measurement section 305.

The measurement section 305 can be constituted by a measurer, a measurement circuit or a measurement device that can be described based on common understanding of the technical field to which the present invention pertains.

<User Terminal>

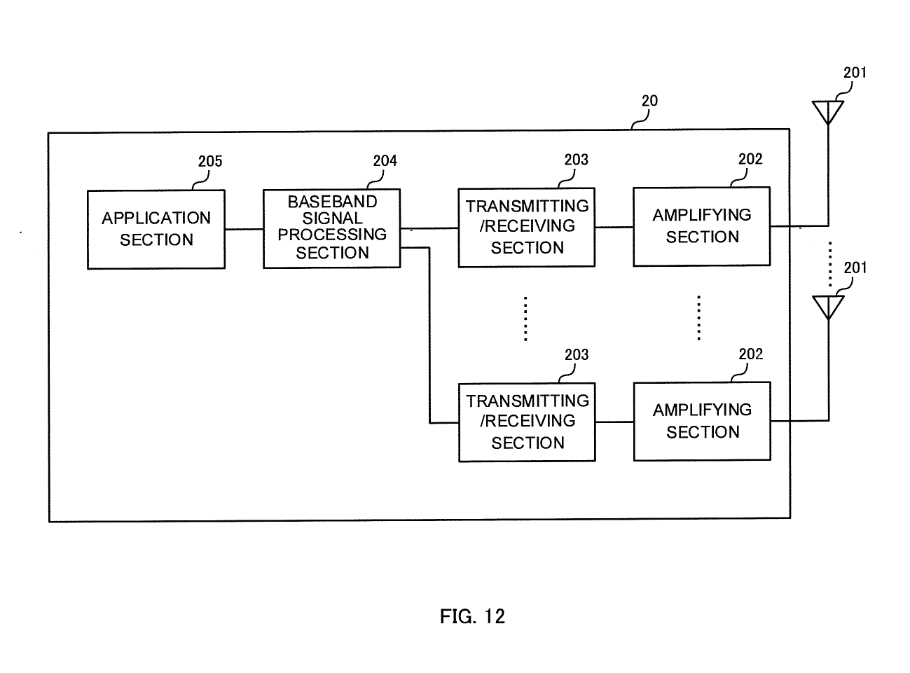

FIG. 12 is a diagram to show an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmission sections and receiving sections.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204.

The transmitting/receiving sections (receiving sections) 203 can receive DL signals (for example, UL grants) that commands UL transmission in unlicensed bands. Furthermore, the transmitting/receiving sections (receiving sections) 203 can receive a discovery signal that includes first reference signals for channel state measurements. In this case, the transmitting/receiving sections (receiving sections) 203 can receive the first reference signals based on reference signal configurations, in which extended resource regions are configured for use for allocation, in comparison to the reference signal configurations applied to existing second reference signals for channel state measurements. Furthermore, the transmitting/receiving sections (receiving sections) 203 can perform the receiving operation by presuming different reference signal configurations for the first reference signals and the existing second reference signals for channel state measurements, based on information about predetermined reference signal configurations (for example, predetermined indices) received from the radio base station. Note that, for the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

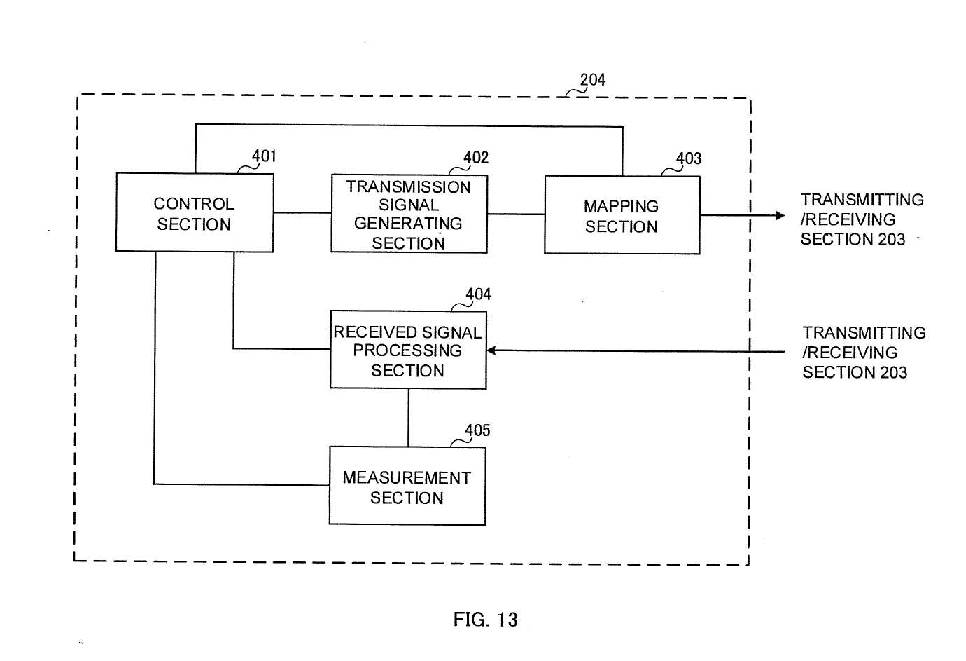

FIG. 13 is a diagram to show an example of a functional structure of a user terminal according to the present embodiment. Note that, although FIG. 13 primarily shows functional blocks that pertain to characteristic parts of the present embodiment, the user terminal 20 has other functional blocks that are necessary for radio communication as well. As shown in FIG. 13, the baseband signal processing section 204 provided in the user terminal 20 has a control section 401, a transmission signal generating section 402, a mapping section 403, a received signal processing section 404 and a measurement section 405.

The control section 401 can control the transmission signal generating section 402, the mapping section 403 and the received signal processing section 404. For example, the control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation/transmission (UL transmission) of uplink control signals (for example, HARQ-ACKs and so on) and uplink data based on downlink control information (UL grants), the result of deciding whether or not retransmission control is necessary for downlink data, and so on. Also, the control section 401 controls the transmission of UL signals based on the result of listening (UL LBT).

Note that, for the control section 401, a controller, a control circuit or a control device that can be described based on common understanding of the technical field to which the present invention pertains can be used.

The transmission signal generating section 402 generates UL signals based on commands from ‘the control section 401, and outputs these signals to the mapping section 403. For example, the transmission signal generating section 402 generates uplink control signals such as delivery acknowledgement signals (HARQ-ACKs) in response to DL signals, channel state information (CSI) and so on, based on commands from the control section 401.

Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal. For the transmission signal generating section 402, a signal generator, a signal generating circuit or a signal generating device that can be described based on common understanding of the technical field to which the present invention pertains can be used.

The mapping section 403 maps the uplink signals (uplink control signals and/or uplink data) generated in the transmission signal generating section 402 to radio resources based on commands from the control section 401, and output the result to the transmitting/receiving sections 203. The mapping section 403 can be constituted by a mapper, a mapping circuit or a mapping device that can be described based on common understanding of the technical field to which the present invention pertains.

The received signal processing section 404 performs the receiving processes (for example, demapping, demodulation, decoding and so on) of the DL signals (for example, downlink control signals that are transmitted from the radio base station in the PDCCH/EPDCCH, downlink data signals transmitted in the PDSCH, and so on). The received signal processing section 404 outputs the information received from the radio base station 10, to the control section 401 and the measurement section 405. Note that, for the received signal processing section 404, a signal processor/measurer, a signal processing/measurement circuit or a signal processing/measurement device that can be described based on common understanding of the technical field to which the present invention pertains can be used. Also, the received signal processing section 404 can constitute the receiving section according to the present invention.

Also, the measurement section 405 may measure the received power (for example, the RSRP (Reference Signal Received Power)), the received quality (for example, the RSRQ (Reference Signal Received Quality)), channel states and so oh, by using the received signals. Furthermore, upon listening that is executed before UL signals are transmitted in unlicensed bands, the measurement section 405 can measure the received power of signals transmitted from other systems and so on. The results of measurements in the measurement section 405 are output to the control section 401. The control section 401 can control the transmission of UL signals based on measurement results (listening results) in the measurement section 405.

The measurement section 405 can be constituted by a measurer, a measurement circuit or a measurement device that can be described based on common understanding of the technical field to which the present invention pertains.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of the radio base station 10 and the user terminal 20 may be implemented by using hardware such as an ASIC (Application-Specific Integrated Circuit), a PLD (Programmable Logic Device), an FPGA (Field Programmable Gate Array) and so on. Also, the radio base stations 10 and user terminals 20 may be implemented with a computer device that includes a processor (CPU), a communication interface for connecting with networks, a memory and a computer-readable storage medium that holds programs. That is, radio base stations and user terminals according to an embodiment of the present invention may function as computers that execute the processes of the radio communication method of the present invention.

Here, the processor and the memory are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes.

Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Also, software and commands may be transmitted and received via communication media. For example, when software is transmitted from a website, a server or other remote sources by using wired technologies such as coaxial cables, optical fiber cables, twisted-pair cables and digital subscriber lines (DSL) and/or wireless technologies such as infrared radiation, radio and microwaves, these wired technologies and/or wireless technologies are also included in the definition of communication media.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “carrier frequencies,” “cells” and so on.

Also, the information and parameters described in this description may be represented in absolute values or in relative values with respect to a predetermined value, or may be represented in other information formats. For example, radio resources may be specified by indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

The examples/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the examples/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, MAC (Medium Access Control) signaling, and broadcast information (MIBs (Master Information Blocks) and SIBs (System Information Blocks))), other signals or combinations of these. Also, RRC signaling may be referred to as “RRC messages,” and can be, for example, an RRC connection setup message, RRC connection reconfiguration message, and so on.

The examples/embodiments illustrated in this description may be applied to LTE (Long Term Evolution), LTE-A (LTE-Advanced), SUPER 3G, IMT-Advanced, 4G, 5G, FRA (Future Radio Access), CDMA 2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosures of Japanese Patent Application No. 2015-160199, filed on Aug. 14, 2015, and Japanese Patent Application No. 2015-187223, filed on Sep. 24, 2015, including the specifications, drawings and abstracts, are incorporated herein by reference in their entirety.

1. A radio base station comprising:
a transmission section that transmits a discovery measurement signal including first reference signals for channel state measurement, based on a result of listening; and
a control section that controls resource allocation of the discovery measurement signal, wherein the control section assigns the first reference signals to be extended greater in a direction of time than existing second reference signals for channel state measurement.

2. The radio base station according to claim 1, wherein the control section assigns the first reference signals by using a reference signal configuration in which a resource region for use for allocation is extended in comparison to a reference signal configuration applied to the second reference signals.

3. The radio base station according to claim 2, wherein:
the discovery measurement signal further includes synchronization signals and cell-specific reference signals; and
the control section assigns the first reference signals to a first resource region and a second resource region, which are arranged to sandwich resources where the synchronization signals and/or the cell-specific reference signals are assigned.

4. The radio base station according to claim 3, wherein:
the transmission section transmits the first reference signals by using predetermined antenna ports; and
the control section assigns a first reference signal corresponding to a predetermined antenna port to a same frequency resource or to different frequency resources between the first resource region and the second resource region.

5. The radio base station according to claim 4, wherein the control section applies four patterns of orthogonal sequences to eight antenna ports, and assigns antenna ports, to which the same orthogonal sequence is applied, to different frequency resources.

6. The radio base station according to claim 1, wherein the number of reference signal configuration patterns to be applied to the first reference signals and the number of reference signal configuration patterns to be applied to the second reference signals are the same.

7. The radio base station according to claim 1, wherein, when a plurality of cells that employ listening are configured for a user terminal, the transmission section transmits information about a discovery measurement signal configuration and/or a channel state measurement reference signal configuration that are applied in common to the plurality of cells, to the user terminal.

8. A user terminal comprising:
a receiving section that receives a discovery measurement signal including first reference signals for channel state measurement; and
a transmission section that transmits channel state information that corresponds to the first reference signals,
wherein the receiving section receives the first reference signals based on a reference signal configuration in which a resource region for use for allocation is extended in comparison to a reference signal configuration applied to existing second reference signals for channel state measurement.

9. The user terminal according to claim 8, wherein the receiving section performs a receiving operation by presuming different reference signal configurations between the first reference signals and the existing second reference signals for channel state measurement, included in the discovery measurement signal, based on information about predetermined reference signal configurations, received from a radio base station.

10. A radio communication method for a radio base station that controls DL transmission based on a result of listening, the radio communication method comprising the steps of:
transmitting a discovery measurement signal including first reference signals for channel state measurement, based on the result of listening; and
controlling resource allocation of the discovery measurement signal,
wherein the first reference signals are assigned to be extended greater in a direction of time than existing second reference signals for channel state measurement.

11. The radio base station according to claim 2, wherein the number of reference signal configuration patterns to be applied to the first reference signals and the number of reference signal configuration patterns to be applied to the second reference signals are the same.

12. The radio base station according to claim 3, wherein the number of reference signal configuration patterns to be applied to the first reference signals and the number of reference signal configuration patterns to be applied to the second reference signals are the same.

13. The radio base station according to claim 4, wherein the number of reference signal configuration patterns to be applied to the first reference signals and the number of reference signal configuration patterns to be applied to the second reference signals are the same.

14. The radio base station according to claim 5, wherein the number of reference signal configuration patterns to be applied to the first reference signals and the number of reference signal configuration patterns to be applied to the second reference signals are the same.

15. The radio base station according to claim 2, wherein, when a plurality of cells that employ listening are configured for a user terminal, the transmission section transmits information about a discovery measurement signal configuration and/or a channel state measurement reference signal configuration that are applied in common to the plurality of cells, to the user terminal.

16. The radio base station according to claim 3, wherein, when a plurality of cells that employ listening are configured for a user terminal, the transmission section transmits information about a discovery measurement signal configuration and/or a channel state measurement reference signal configuration that are applied in common to the plurality of cells, to the user terminal.

17. The radio base station according to claim 4, wherein, when a plurality of cells that employ listening are configured for a user terminal, the transmission section transmits information about a discovery measurement signal configuration and/or a channel state measurement reference signal configuration that are applied in common to the plurality of cells, to the user terminal.

18. The radio base station according to claim 5, wherein, when a plurality of cells that employ listening are configured for a user terminal, the transmission section transmits information about a discovery measurement signal configuration and/or a channel state measurement reference signal configuration that are applied in common to the plurality of cells, to the user terminal.

19. The radio base station according to claim 6, wherein, when a plurality of cells that employ listening are configured for a user terminal, the transmission section transmits information about a discovery measurement signal configuration and/or a channel state measurement reference signal configuration that are applied in common to the plurality of cells, to the user terminal.
